(19) United States
(12) Patent Application Publication
(10) Pub. No.: US 2008/0096177 A1
(43) Pub. Date: Apr. 24, 2008

(54) AUDIENCE RESPONSE SYSTEM GAMES

(76) Inventor: Darin Beamish, Puyallup, WA (US)

Correspondence Address: DWC LAW FIRM, P.S., P.O. BOX 3041, SEATTLE, WA, 98114-3041, US

(21) Appl. No.: 11/748,687

(22) Filed: May 15, 2007

Related U.S. Application Data
(63) Continuation-in-part of application No. 11/584,346, filed on Oct. 19, 2006.

(51) Int. Cl. G09B 3/00

(52) U.S. Cl. 434/351

(57) ABSTRACT

Methods and systems for playing games in an audience response system. Spontaneous inquiries can be posed by a presenter during a game, and portable wireless transmitter units can be used to respond to the inquiries. The responses are evaluated and the results are reflected in a graphical presentation displayable to audience members. The spontaneous inquiries can be selected from a set of paper-based questions provided to audience members.

### CROSS REFERENCE TO RELATED APPLICATION

This application is a continuation-in-part of U.S. patent application Ser. No. 11/584,346, filed Oct. 19, 2006, which application is incorporated herein by reference in its entirety.

### BACKGROUND OF THE INVENTION

1. Field of the Invention

The present invention relates to audience response systems for use in audience participation, and more particularly, to systems and methods for playing educational games using audience response systems.

2. Description of Related Art

Audience response systems typically include a host unit connected to a computer, and a plurality of remotely operable portable units in wireless communication with the host unit. The portable units are often keypad devices having transmitters and receivers. The portable units can include one or more presenter units, and multiple audience member portable units. The presenter unit can be uniquely configured to have functionality in addition to that of the audience member portable units, and may be usable to transmit commands to the audience response system. Audience members can use the portable units to send and receive data and information to and from the host unit, for interacting with the audience response system.

All of the portable units (including the presenter unit) can have dedicated display devices. The dedicated display devices may be compact LCD systems, small enough so as to avoid rendering the portable units cumbersome, such that the portable units remain more compact than a typical laptop computer, and can be handheld.

Audience response systems are often used to play interactive games. In class room environments, for example, it is believed that audience response system games stimulate participation, and enhance learning. Some example games include posing inquiries to audience members (e.g., students) and collecting responses through the portable units, processing the responses using a computer, and displaying graphical presentations on a common display visible by all audience members, such as animations that reflect the results of the processing of responses. The audience member responses can influence the graphical presentations, or the progress of graphical presentations (e.g., graphical animations that relate to overall scores for each audience member, or team of audience members). When the graphical presentations progress, they can do so as a function of cumulative responses collected overtime during a particular game.

Games played in the fashion described above are commonly based on pre-associated inquiries (or questions). That is, for example, a presenter may create or select a set of inquiries ahead of time to be used with a particular game, such as by designating an electronic answer key at the computer to be used with a game and announcing the inquiries verbally in an order corresponding to the answer key. Alternatively, the inquiries themselves can be stored electronically into the graphical presentation to be presented as, for example, textual questions, while also providing an electronic answer key to the computer for scoring responses. When the game is launched, it is played using the pre-associated inquiries in the order in which they have been pre-associated with the graphical presentation. Each time an inquiry is presented, the responses are collected, and the graphical presentation progresses as a function of the processing of the responses collected. This rigidity can be restrictive in an audience environment and in a game environment, where flexibility and dynamic changes may add to the enhancement of learning and the excitement of the game.

### BRIEF SUMMARY OF THE INVENTION

In some embodiments of the present invention, methods of playing a game using an audience response system are provided, wherein the audience response system includes a computer linked to a host unit, the host unit being in wireless communication with a plurality of portable units.

The methods can include posing inquiries to a plurality of audience members, the inquiries being posed from a series of inquiries that are pre-associated with a graphical presentation of the game. Responses to the inquiries are received at the host unit, as transmitted from the plurality of portable units by audience members. A graphical presentation is displayable, which can be animated, and reflective of evaluations of the responses received for the inquiries. In addition, a presenter (such as a teacher in a classroom administering the game) can interject in the game and pose spontaneously selected inquiries. The spontaneously selected inquiries can be posed by the presenter while observing a game, at the presenter's discretion. For example, the presenter may want to turn the tide of game, emphasize a question type with a particular focus after watching progress in the game, lengthen the game, etc., all of which may be reasons to interject with spontaneous inquiries.

The graphical presentation (which can include a multi-media segment or presentation) is displayable to the audience members on a commonly viewable display and can be reflective of an evaluation of cumulative responses received during the game, including responses received to the pre-associated series of inquiries, as well as spontaneous inquiries.

In some embodiments of the present invention, spontaneous inquiries can be posed to audience members during a game, with the spontaneous inquiries being selected from a paper-based question set. Posing the spontaneous inquiries can comprise indicating a question identifier to audience members, who can then refer to paper-based question sets to determine the question and respond using keypad on portable units. Such paper-based spontaneous inquiries can be posed independently, or in an interjecting fashion during a game based on a pre-associated set of inquiries. Both the spontaneous inquiries and pre-associated inquiries can be based on the same paper-based question set.

### BRIEF DESCRIPTION OF SEVERAL VIEWS OF THE DRAWINGS

FIG. 1 is a diagram showing major components of an embodiment of an audience response system of the present invention.

FIG. 2 is a plan view of an embodiment of a portable unit for use with some embodiments of the present invention.

FIG. 3 is a simplified block diagram of an embodiment of the portable unit of FIG. 2.

FIG. 4 is a simplified block diagram for a computer, such as a PC, usable with some embodiments of the present invention.

FIGS. 5-8 illustrate examples of user interface settings displayable on the display device of the portable unit of FIG. 2.

FIG. 9 shows an embodiment of a setup screen of a graphical user interface for some embodiments of the present invention.

FIG. 10 is a diagram illustrating a portable unit operating in accordance with a modified question-set for some embodiments of the present invention.

FIG. 11 is a flow diagram for an embodiment of the present invention for playing a game using a paper-based question set, wherein the questions are presented in the order in which they have been pre-associated with a graphical presentation.

FIG. 12 is a flow diagram for an embodiment of the present invention for posing spontaneous inquiries during a game played using the audience response system.

FIG. 13 is a flow diagram for an embodiment of the present invention where an audience response system is used to play a game that integrates both spontaneous and non-spontaneous inquires, with a base set of pre-associated inquiries being usable to “run” the game, while allowing a presenter to interject with spontaneous inquiries.

FIG. 14 is a flow diagram for an embodiment of the present invention wherein a presenter can pose questions from a paper-based question set spontaneously.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known or widely available hardware, software and wireless systems associated with audience response systems have not been described in detail to avoid unnecessarily obscuring the descriptions of the embodiments of the invention.

Various embodiments of the present invention are described for purposes of illustration, in the context of a radio frequency (RF) communications link. However, as those skilled in the art will appreciate upon reviewing this disclosure, other methods of wireless communication may be suitable, such as, for example, infrared (IR). Also, various embodiments of the present invention are described in the context of students providing responses to paper-based questions. Those skilled in the art will appreciate that the same or substantially similar methods, systems, graphical user interfaces can be used in a variety of audience settings without deviating from the spirit of the invention.

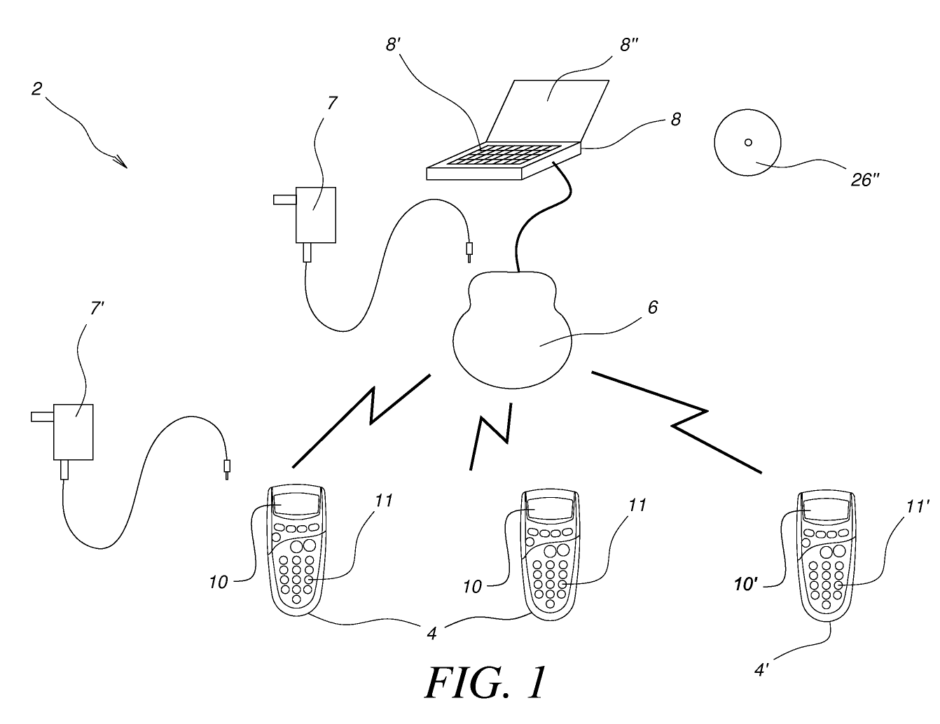

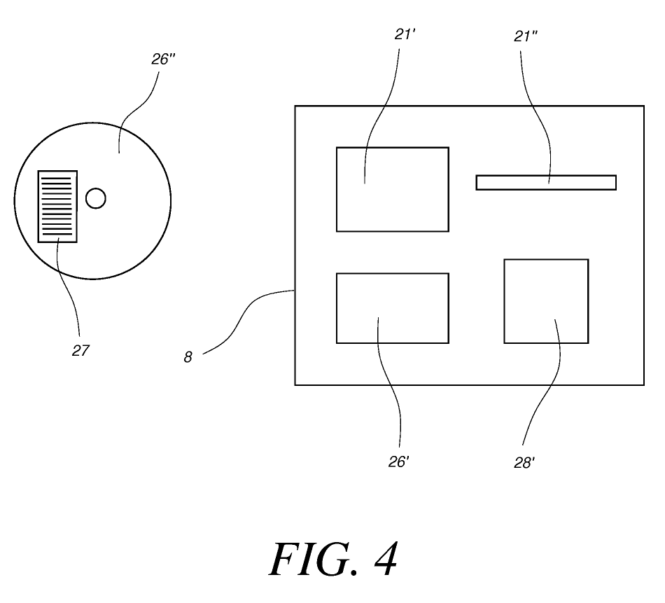

In some embodiments of the present invention an audience response system 2 is provided, having one or more portable units 4 and a host unit 6, as can be seen in FIG. 1. The portable units 4 can include a presenter unit 4′. The presenter unit 4′ may be pre-associated to have certain access rights to functions of the audience response system 2 not accessible to users of the other portable units 4, as will be appreciated by those skilled in the art after reviewing this disclosure. The host unit 6 may be communicatively connected to a computer 8, including, for example, a laptop or desktop PC, normally having a keyboard 8′, mouse or pointer (not shown) and monitor or display device 8″. Referring to FIG. 4, the computer 8 can also include a CPU or processor 21′, hard drive 26′ or other non-volatile memory, and a device 21″ for reading instructions or data from a computer readable medium 26″, such as, for example, but not limited to, floppy disks, digital compact discs, tapes, flash memory, etc. Various applications usable with the audience response system 2 can be executed using the computer 8.

A wireless communication link can be provided between the portable units 4 and the host unit 6 using infrared or radio frequency methods, structures, systems and related communication protocols, as will be appreciated by those skilled in the art after reviewing the present disclosure. For example, in some embodiments, wireless infrared communication is employed between the portable units 4 and host unit 6 using a polling method to avoid signal collisions, while in other embodiments, wireless radio frequency (RF) communication is employed, such as, for example, without limitation, by use of an IEEE 802.15.4 compliant communications link.

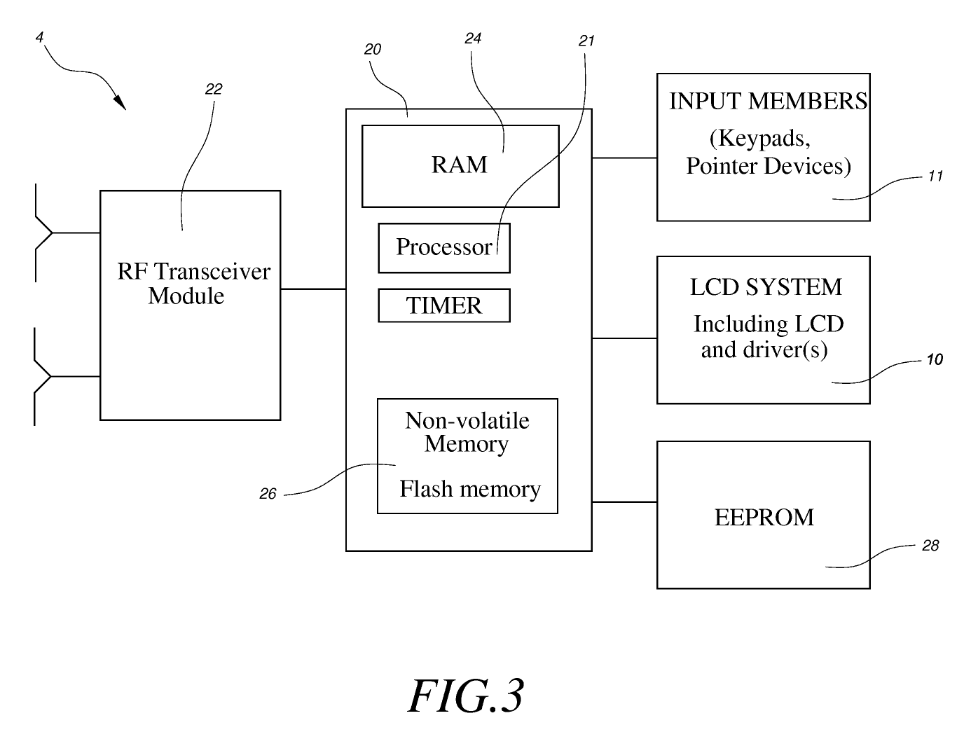

Various embodiments of the portable units 4 can be provided, including that illustrated as a simplified block diagram in FIG. 3, which can comprise a display (LCD) 10 (such as a liquid crystal display system with driver), input members 11 (e.g., manually operable input members such as, for example, keys, buttons, switches and pointers), an RF transceiver unit or module 22 and a microcontroller 20 having a processor 21, along with integral or peripheral RAM 24, writable non-volatile memory 26, such as flash memory, and programmable read only memory, such as, for example, EEPROM 28.

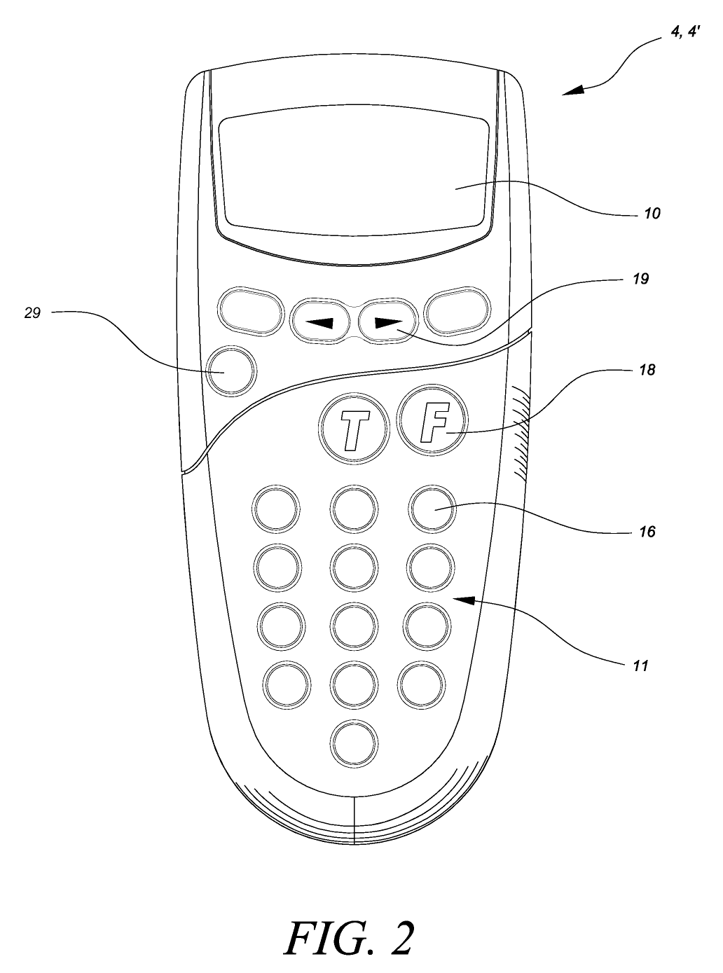

Referring to FIG. 2, some embodiments of the portable unit 4 have various manually operable input members 11, which can include scroll keys 19 and an alphanumeric keypad 16. Some input members 11 can be multifunctional, and configured to be operable in different modes, as will be appreciated by those skilled in the art after reviewing this disclosure. Designated keys 18 can be signified by one or more types of permanent markings on the keys or a surface of the portable unit 4, such as, for example, “YES” or “NO,” or “T” or “F” (signifying “TRUE” or “FALSE” in some embodiments) markings to simplify action required by a user to input responses to certain types of inquiries. Other designated keys can also be provided to simplify initiation of functions, such as, for example, a designated key for initiating a wireless transmission (e.g., sending a response to an inquiry).

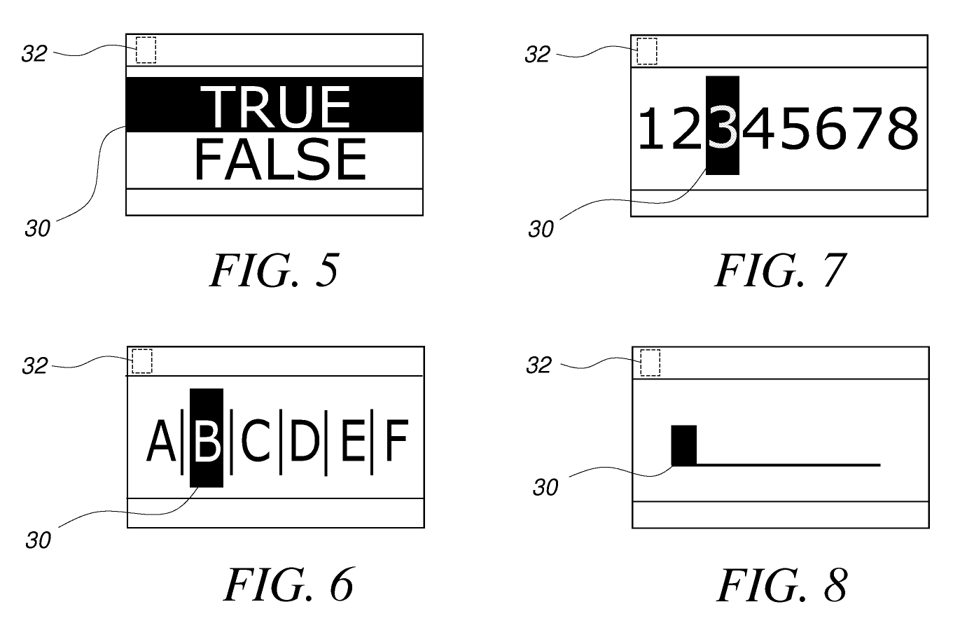

The scroll keys 19 can be used to navigate or make selections in user interfaces settings provided on the display device 10. For example, the display device 10 can display the user interface settings in FIGS. 5-8, with each setting comprising a cursor 30 that is moveable using the scroll keys 19. The cursor 30 can be moved to select or enter answer choices such as “TRUE” or “FALSE” in FIG. 5, any of the letters in FIG. 6, any of the numbers in FIG. 7, or any location in the data entry field in FIG. 8. Each of the selectable choices can represent responses to questions (or inquiries) that are provided to, or posed to, audience members. Also, the alphanumeric keypad 16 can be used to select answer choices or to type in answers on the display device 10.

Referring to FIG. 4, in some embodiments, one or more application programs 27 (the application program is illustrated in FIG. 4 as being instructions on an external disc, but can be transferred or stored in any of various available mediums as will be appreciated by those skilled in the art upon review of this disclosure) can be executed by the computer 8 to, among other things, display, evaluate and analyze responses to inquiries transmitted to the host unit 6 from audience members using the portable units 4. The application program can be provided on a computer readable medium 26″ such as, without limitation, floppy disks, CD-ROM disks, tapes, flash memory, system memory, DVD-ROM, or hard drives. The application program 27, or one or more separate programs, can also provide a graphical user interface (GUI) on the computer 8 for use by a presenter (such as a teacher) to implement and configure various activities, including, without limitation, to generate presentations for display to an audience that include inquiries, surveys, games, educational lessons and quizzes, etc, as will be described in further detail herein.

In some embodiments of the present invention, the audience response system 2 is used in a teaching environment, such as a classroom or other instructional or educational setting. In such environments, audience members (e.g., students) are often provided paper-based question-sets. The questions sets can be, for example, questions that are provided at the end of each chapter in a text book, or a paper-based test or quiz for grading or assessment purposes. In various embodiments of the present invention, digital answer keys files, corresponding to the paper-based question-sets, can be provided in compatible data file format for use with an application program 27, and stored on a memory device of computer 8. In such embodiments, audience members can utilize the portable units 4 to respond to the questions in the paper based question-sets, with their answers being transmitted to host unit 6 for analysis and grading at a processor, such as processor 21′, on the computer 8, as will be appreciated by those skilled in the art upon review of this disclosure.

For each paper-based question-set, a particular combination of user interface settings can be displayed on the display 10 of the portable units. For example, any given question-set can comprise a combination of different answer formats (e.g., multiple-choice, true or false, or open response), with different associated possible answers. Thus, as shown in FIGS. 5-8, different user interface settings are provided for different answer formats. However, it can be desirable to pre-associate a user interface setting with each question in a question-set. Therefore, in some embodiments of the present invention, when an audience member uses the portable unit 4, an appropriate user interface setting is automatically displayed on the display device 10 of the portable unit 4 for each particular question the audience members selects to work on. This can be accomplished by, for example, transmitting instructions to the portable units 4 that allow the portable units to associate any particular selected question number with a particular user interface setting.

In order to identify what sequence of user interface settings a portable unit 4 should use for a particular question-set, a question-set identifier (which can be, for example, a numerical code) can be provided to computer 8. That is, an audience member provided with a paper-based question-set is also provided with a question-set identifier unique to the particular question-set, which can be entered into the portable unit 4 using keypad 11, then transmitted to the host unit 6. Also, the teacher can use the computer 8 to enter a question-set identifier that is used to control the sequence of interface settings of the portable units 4. Thereafter, the host unit 6 can transmit instructions to the portable unit 4 to control interface settings, or can transmit an instruction set for use by the portable unit 4 for selecting interface settings while the portable unit 4 is used for a particular question set.

It is also noted that in some embodiments of the present invention, the application program 27 provides the option of allowing control of all or any one or more of a plurality of portable units 4 on a network using any particular question-set identifier. In this way, all portable units can be used to work on the same question-set, or different portable units can be used to work on different question-sets simultaneously.

Often, it is desirable for the presenter, such as a teacher in an educational setting, to require audience members to answer only a portion of a particular paper-based question-set. For example, teachers often assign only odd or even questions from a particular question-set in a text book, sometimes with certain questions skipped in between others. In such cases, audience members utilizing the portable unit 4 may need to scroll through the question numbers 32, displayed on the portable units 4 in order to skip certain questions not assigned. That is, during some operations, when an audience member is using the portable unit, he or she scrolls though question numbers on the display 10 in order to proceed to a next question before answering. Thus, when only a portion of the questions on a paper-based question-set are assigned, the audience member needs to scroll to “skip” questions.

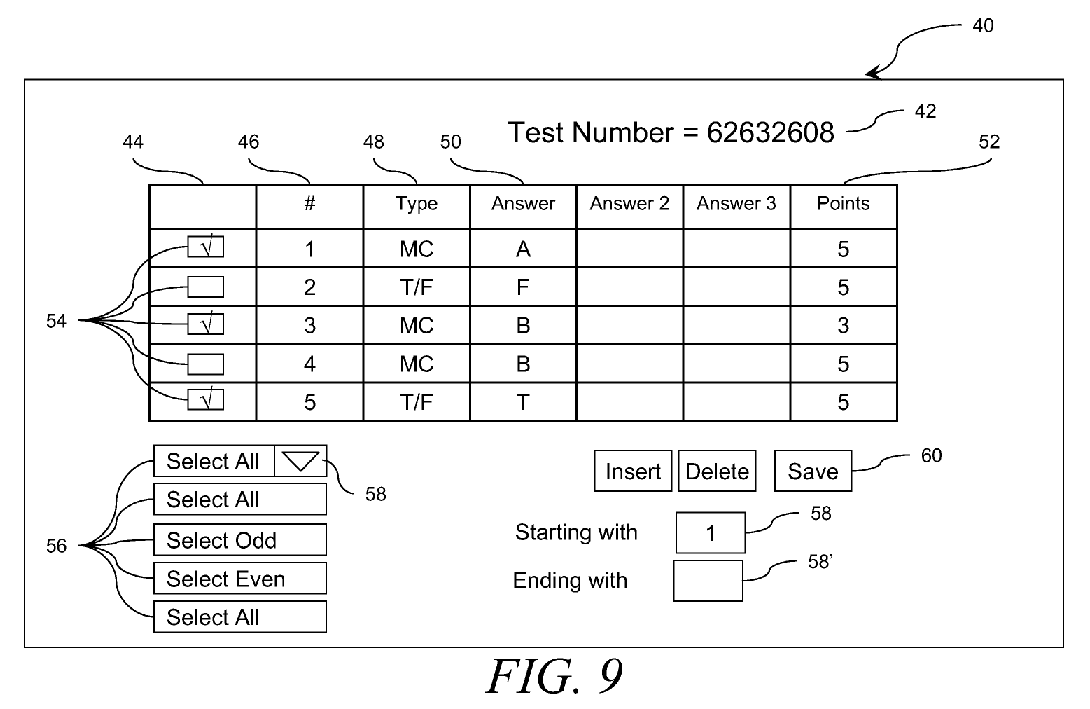

Referring to FIG. 9, in some embodiments of the present invention, it is desirable to provide a user interface having a setup screen 40, displayable on a display device of computer 8, in which a presenter (such as a teacher) can select questions that are to be associated with a modified question-set. The modified question-set is then, for example, a subset of a paper-based question-set (the entire paper-based question-set can also be referred to as a master question-set). For example, the teacher can use the setup screen 40 to select a master question-set identifier 42. In the illustrated example in FIG. 9, the master question-set has five (5) questions, as represented by question indicia shown in column 46. Three of the questions in the master question-set are multiple choice (“MC”) questions and two are true/false (“T/F”) questions, as shown in column 48. The teacher can produce data to be used for administering a modified question-set. This can be accomplished by, for example, clicking on one or more graphical sections, such as boxes 54, provided in column 44 of the setup screen 40, each box being associated with particular question indicia representing a question of the master question-set. In the illustrated example in FIG. 9, the teacher is assigning only three questions from the master question-set having five questions, and has selected questions one (1), three (3), and five (5) using the graphical boxes 54 in column 44. This subset of questions is also referred to herein as a modified question-set. Thereafter, the teacher can assign a new modified question-set identifier, which can be displayed in the setup screen 40, and can save the modified question-set data, if desirable.

In some embodiments of the present invention, the modified question-set does not require a modified answer key file to be generated, as responses to questions transmitted from the portable unit 4 automatically include information as to which question number to associate the answer with. Thus, the original answer key file for the master questions set is sufficient for the application program 27 to grade the responses. In other embodiments, a separate modified answer key is generated for association with each modified question-set.

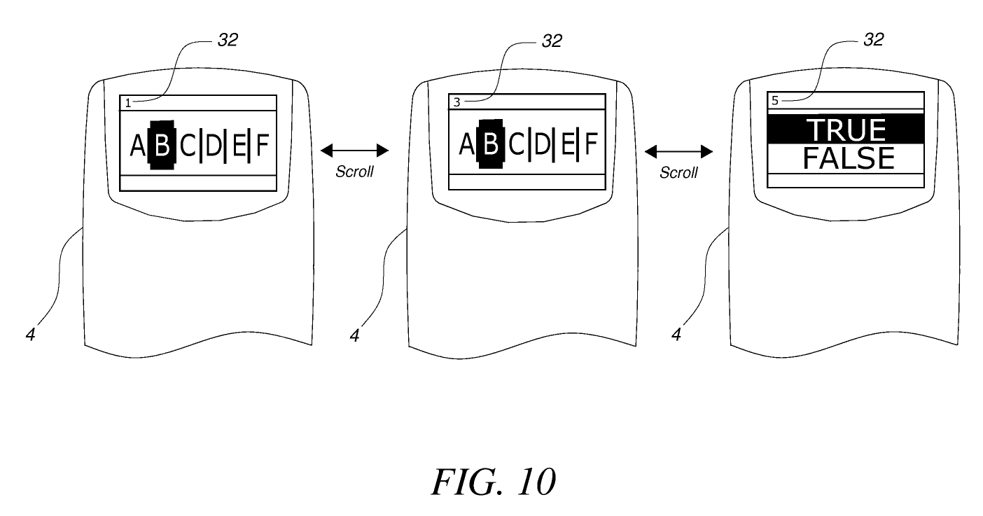

The modified question-set data can be utilized by the application program 27 to transmit instructions to control the portable units 4 such that audience members can only provide answers to the questions within the modified question-set. Thus, for the example, a portable unit 4, used to respond to questions in the modified question-set illustrated in FIG. 9, can be instructed to allow an audience member to only scroll through (e.g., using keys 19 for example to scroll), or select (e.g., pressing a key from alphanumeric keypad 16), question numbers representing questions included in the modified question-set, namely, questions one (1), three (3), or five (5). FIG. 10 illustrates example user interface settings of the portable unit 4 being displayed as a result of an audience member scrolling through the question numbers representing the modified question-set of FIG. 9. All other question numbers, and associated user interface settings, can be inaccessible while the user is working on the modified question-set.

As will be appreciated by those skilled in the art after reviewing this disclosure, providing instructions to any one or more portable units 4 to operate in accordance with a particular modified question-set only, can be executed by, for example, a teacher providing a particular modified question-set identifier to computer 8, after which a corresponding instruction can be transmitted to one or more portable units 4 via host 6. The computer 8 (with application program 27) can also be used to select a particular portable unit 4, group of portable units, or all portable units on a network (e.g., the entire classroom), to operate in accordance with a particular modified question-set. Furthermore, in some embodiments of the present invention, a setting can be selected that allows audience members to transmit an identifier corresponding to particular modified question-set, so that the audience members can operate their particular portable unit 4 in accordance with a particular modified question-set.

Also, it is noted that in some embodiments of the present invention, the audience member will not need to be informed ahead of time which questions to answer from a paper-based document, since the portable unit 4 can automatically guide the audience member when operating in accordance with a modified question-set, thereby displaying question indicia (e.g., letters, numbers, titles) corresponding only to those paper-based questions that are to be answered.

Referring again to FIG. 9, in some embodiments, a teacher is provided with a plurality of additional function shortcuts for efficiently modifying a question-set within a setup screen 40. A graphical section, such as a tab 58, can be provided which can be used to pull down a menu of selectable options 56. The selectable options 56 can include “Select All,” to select all questions within a master question-set, “Select Odd” to select only odd questions within the question-set, and “Select Even,” to select only even questions within a question-set. Furthermore, even after one of the selectable options 56 is chosen, the teacher can further adjust the modified question-set by selecting or deselecting the boxes 54 associated with any number of particular questions. In addition, the teacher can select which question the modified question-set will start with using field 58, or end with using field 58′. In some answer key files, or other associated files, points may be pre-associated with questions in a question-set, with the points being used to calculate a point total for determining an audience member grade for a particular question-set. To provide flexibility for a teacher when selecting data for a modified question-set, the points associated with any particular question in a modified question-set can also be adjusted or selected, by manually entering a number of points associated with the question in column 52.

Audience response systems are commonly used to play educational games, as will be appreciated by those skilled in the art. Another embodiment of the present invention involves the utilization of preprinted paper-based questions in association with games. A presenter (which can be a teacher in a classroom) can use a setup screen 40 to create data for a modified question-set. The presenter can then associate a particular interactive graphical presentation (i.e., game graphic) with the data for the modified question-set. The graphical presentation can be displayable on a common display, such as, for example, without limitation, a projection screen.

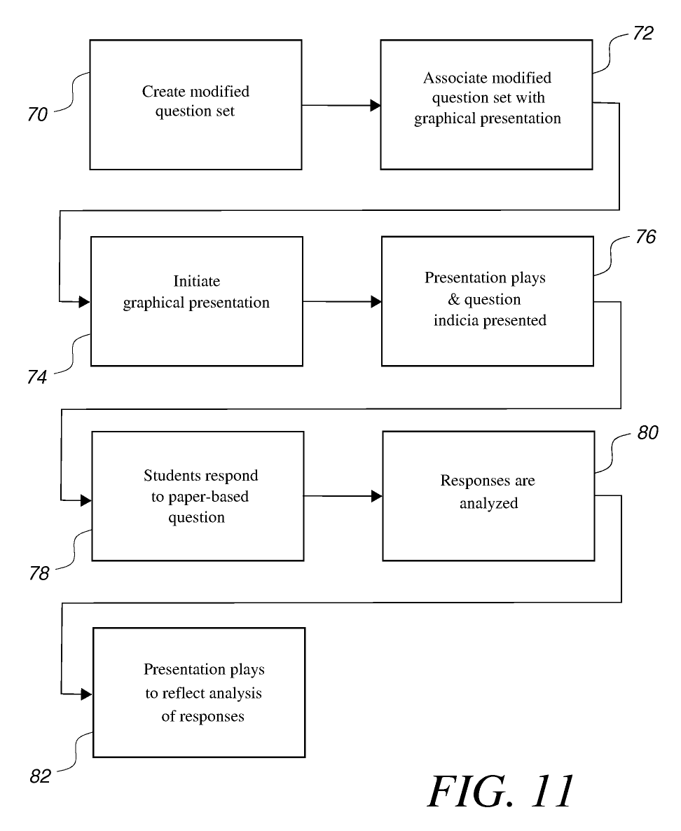

In some example embodiments of the present invention, the graphical presentation is an audiovisual presentation. An audience can be made up of teams of students in a classroom to which a presenter wants to present the modified question-set as a team played game, in which the scores of the teams are compared. The graphical presentation can comprise, for example, sound and graphics representing racing cars that race around a track and travel a particular distance in proportion to the current score of a team. Referring to FIG. 11, in some example embodiments, the presenter can create data associated with a modified question-set in step 70 using the setup screen 40. The presenter then uses an application program 27 to associate the modified question-set data with a graphical presentation (such as the racing car example described above), at step 72. The students are asked to refer to a particular pre-existing paper based question-set (e.g., a question-set in a chapter of their textbook) and the graphical presentation is initiated at step 74 (e.g., a visual representation of racing cars associated with each team, positioned at a starting line). A first question in the modified question-set is displayed, such as, for example, by question number (e.g., the common display instructs audience members to answer question number three (3) of their text book, the portable units 4 used by the audience members show the question number, or the question number is displayed both on the common display and portable units 4 used by the audience members), at step 76. That is, the display (common display or portable unit 4 display) does not need to display the text of a question, but instead may only display a question number.

Thereafter, the audience members then refer to their paper-based documents to read the question associated with the question number displayed, and respond to the question, at step 78. Also, in some embodiments, the audience members do not need to scroll or select question numbers, as the portable units 4 are acting in accordance with the modified question-set associated with the graphical presentation. In some embodiments of the games of the present invention, an instruction to display a particular question number and a particular user interface setting is transmitted to the portable units 4 for each question displayed (or transmitted for a set of questions to be displayed during a game if the questions are to be presented in a pre-set order), the portable units 4 thereby being synchronized with the graphical presentation of the game so that students, or users, do not have to select any question using the portable units 4, but instead, just respond to the question within the user interface setting presented to them currently. At step 80, the responses of each audience member are analyzed (which can include grading and adding all scores of audience members associated with a particular team). At step 82, the graphical presentation can reflect the points earned by each team, such as by, for example, advancing the graphically represented racecars for each team a distance proportional to the total scores for the corresponding team.

In some embodiments of the present invention, the audience members can be provided with different paper-based question-sets, as selected by a presenter. Thus when the question number or indicator is displayed to audience members, the question text that each audience member sees on his or her paper-based question-set can be different from audience member to audience member. When different paper-based question-sets are provided to the audience for use in a game, the audience responses can be checked against different answer keys, which may be associated with particular audience members at the computer 8, as will be appreciated by those skilled in art after reviewing this disclosure. The use of different paper-based question-sets can provide flexibility for a presenter such as by, for example, allowing a presenter to provide questions of differing difficulty, or differing focus, for different audience members during game activities, or otherwise.

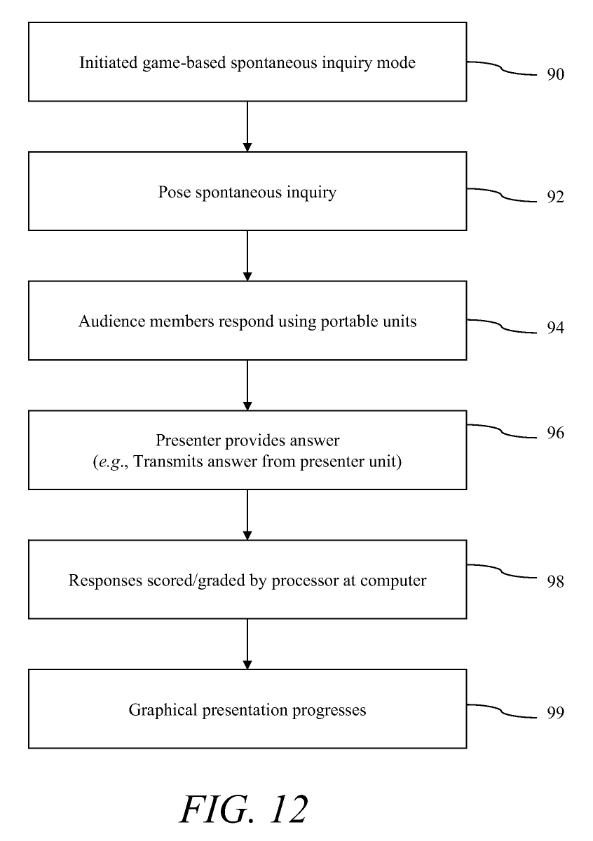

In further embodiments of the present invention, game questions are spontaneously selected by a presenter, or are selected without a preset order. For example, referring to FIG. 12, at step 90, the presenter can use input members 11 on the presenter unit 4′ to instruct the audience response system 2 to enter a game-based spontaneous inquiry mode, wherein the portable units 4 are placed in a waiting mode operable to receive audience member responses to the spontaneous question posed. (The term “waiting mode,” is not intended here to be limiting as to the particular communications protocol between the portable units and the host unit, but refers only to the portable units being in a mode capable of receiving entry data from an audience member in response to a spontaneous inquiry and transmitting that data to the host unit 6 as a response to the spontaneous inquiry). The waiting mode can allow audience members to key in any response, such as a number or letter selection using input members 11 on the portable units 4. In other embodiments, the presenter can also specifically select an appropriate user interface setting during the waiting mode, such as, for example, a user interface setting showing a multiple choice answer selection format, such as that described previously in reference to FIG. 6. At step 92, the presenter may pose a spontaneous question verbally or visually using presentation software. At step 94, audience members send their responses to the spontaneously posed inquiry using the portable units 4. At step 96, after collecting responses, the presenter can key in an answer to the spontaneous question posed, by using the presenter unit 4′ or the computer 8. At step 98, the responses can be scored by the processor at the computer 8. Finally, at step 99, after the responses are scored or otherwise evaluated by the computer 8, the graphical presentation can be shown on the common display to advance the game (e.g., graphical representations of racing cars are shown progressing in an amount proportional to the scores for the recent spontaneous question).

As will be appreciated by those skilled in the art after reviewing this disclosure, the above steps 90, 92, 94, 96, 98 and 99 do not necessarily need to be carried out in the exact order described. For example, the step 96, wherein the presenter provides an answer to the spontaneous inquiry, can occur at any time prior to scoring the response. The answer provided by the presenter can be saved at a memory at computer 8. After responses are collected from all audience members, or after the presenter sends a command to the computer 8 to close the current inquiry, the collected responses are analyzed and compared against the most recent answer provided by the presenter. A graphical presentation can then progress as a function of the analysis.

In further embodiments of the present invention, the game-based spontaneous inquiry mode can be integrated with pre-associated inquiries to provide a highly flexible game environment for an audience response system 2. The pre-associated inquiries can be independently created, or can be part of, or all of, a modified question-set, or master question-set, as previously described and as illustrated in FIG. 11. In the embodiments where the pre-associated inquiries for a game include a modified-question set, the inquiries are associated with a particular interactive graphical presentation (i.e., game graphic) and with instructions, if any, to the portable units to control user interface settings so that they operate in accordance with the modified-question set.

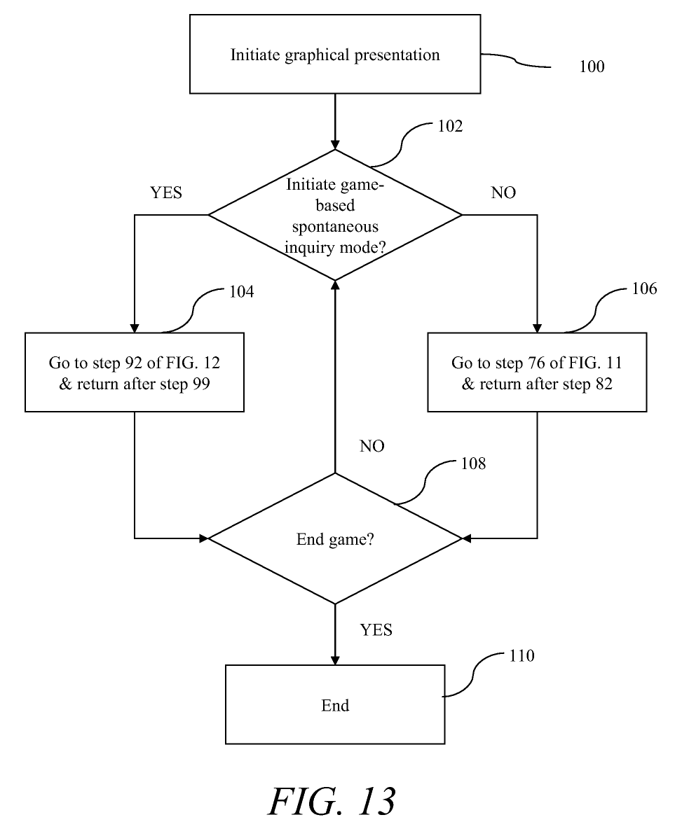

Turning to FIG. 13 which illustrates an embodiment of the present invention, at step 100, a graphical presentation for a game is initiated, with the graphical presentation having been pre-associated with a question set, which can be a modified question-set. A presenter can then elect whether to initiate the spontaneous inquiry mode at step 102, or whether to allow a graphical presentation to progress in sequence with the pre-associated question set. If the spontaneous inquiry mode is initiated, at step 104, the presenter can pose a spontaneous inquiry starting with step 92 of FIG. 12 (previously discussed), progressing through step 99 of FIG. 12 with the graphical presentation progressing, before returning to step 102 again, where the presenter is again allowed to elect whether to initiate a spontaneous inquiry mode. If not, the present can allow the game to progress in a sequential order with the pre-associated questions at step 106. The game then progresses in a manner illustrated by FIG. 11 from steps 76 through step 82, wherein the presentation plays to reflect the analysis of responses, before returning to step 102 of FIG. 13. At any point in time, or at any time after responses are collected and analyzed, the game can end at step 110, or return to step 102, where again, the presenter can elect to initiate a spontaneous inquiry mode. If no spontaneous inquiry mode is elected, the game can continue to progress in sequential order with the pre-associated questions.

The above method and system provide for, among other things, flexibility, enhanced interactive participation and control for a presenter during a game. The presenter can “run” a game based on a pre-associated question set (which can be an independent question set provided by a presenter, or a modified-question set from a paper-based question-set) and the presenter may interject at any time spontaneously. This ability to interject during a game with spontaneous questions provides the presenter an ability to guide the game based on results the presenter perceives during the game.

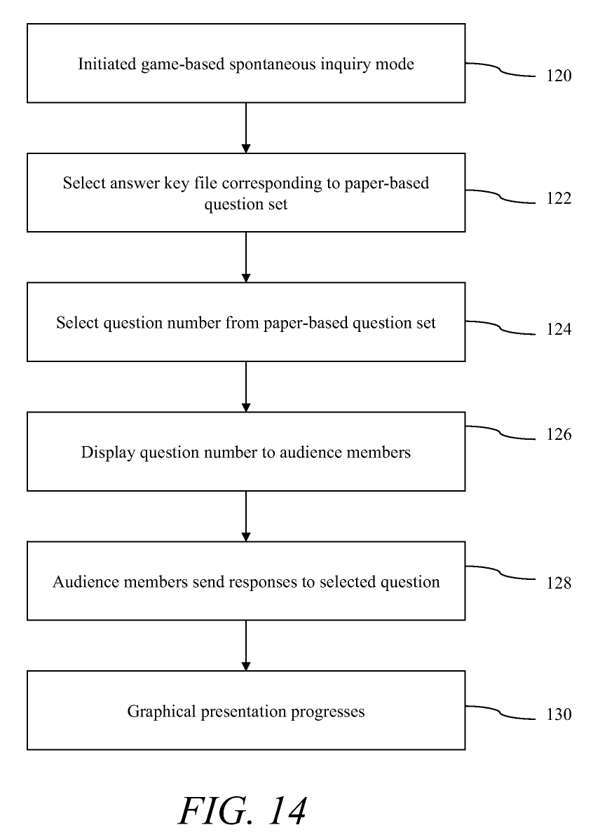

In yet another embodiment of the present invention, a presenter can spontaneously pose questions from a paper-based question-set. For example, referring to FIG. 14, at step 120, the presenter keys in a command using input members 11 on the presenter unit 4′ to instruct the audience response system 2 to be in a game-based spontaneous inquiry mode. At step 122, the presenter can select a particular answer key file, corresponding to a paper-based question-set to which the audience currently has access. At step 124, the presenter keys in a question number using the presenter unit 4′ to pose a question from the paper-based question-set spontaneously. At step 126, the question indicator (e.g., question number) can be displayed on a common display (or on the portable units 4 of the audience members) and an appropriate user interface setting can be displayed on each of the portable units 4 by instruction sent by the host unit 6. At step 128, audience members can refer to the paper based question-set to review the indicated question, and enter a response in the portable units 4. The user interface setting of each portable unit 4 can be automatically set to correspond with the question selected by the presenter. The audience members' responses can be sent back with an associated question identifier so that the response can be properly matched against the answer key, or, alternatively, each audience member's response is immediately checked against the current applicable answer to determine a score. Thereafter, at step 130, the graphical presentation for the game can be redisplayed, again showing progress for each audience member or team.

In some embodiments of the present invention, when the game-based spontaneous inquiry mode is integrated with pre-associated inquiries, each time the spontaneous mode is elected, the presenter can indicate a question number of a paper-based question set in the manner described above, and illustrated in FIG. 14.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices, systems and methods can omit some elements or acts, can add other elements or acts, or can combine the elements or execute the acts in a different manner or order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A method of playing a game using an audience response system, wherein the audience response system includes a processor and a host unit in wireless communication with a plurality of portable units, the method comprising:
posing a first inquiry to a plurality of audience members, the inquiry being one of a series of inquiries pre-associated with a graphical presentation displayable to the audience members;
receiving responses to the first inquiry at the host unit transmitted from the plurality of portable units;
displaying the graphical presentation as a function of an evaluation of the responses received for the first inquiry;
posing at least a second inquiry to the plurality of audience members, the second inquiry being a spontaneously selected inquiry which is independent from the series of inquiries; and
displaying a graphical presentation that is reflective of an evaluation of cumulative responses received during the game, including responses received to the first inquiry and second inquiry, whereby a game played using the audience response system can include both pre-associated and spontaneous inquiries.

2. The method of claim 1 wherein answer data corresponding to the second inquiry is transmitted to the host unit remotely by a presenter using a portable unit.

3. The method of claim 1 wherein a presenter initiates a command to the audience response system that places the portable units in a waiting mode for receiving responses from the audience members for the second inquiry, and wherein the presenter provides answer data to the processor for use in scoring responses to the second inquiry.

4. The method of claim 3 wherein the answer data is transmitted to the host unit by the presenter using a portable unit.

5. The method of claim 3 wherein the command also places the portable units in a particular user interface setting.

6. The method of claim 1 wherein the audience members are provided with a paper-based question set, and wherein the second inquiry is a question spontaneously selected by a presenter from the paper-based question-set.

7. The method of claim 1 wherein the audience members are provided with a paper-based question set and wherein the first inquiry is posed by displaying a question identifier to the audience members corresponding to a question on the paper-based question set.

8. The method of claim 7 wherein the second inquiry is a question spontaneously selected by a presenter from said paper-based question-set.

9. A method of playing a game using an audience response system, the method comprising;
initiating a spontaneous inquiry mode wherein a plurality of portable units are placed in a mode operable for receiving and transmitting responses to a spontaneous inquiry;
posing a spontaneous inquiry before or after initiating the spontaneous inquiry mode;
receiving responses at a host unit in response to the spontaneous inquiry;
receiving answer data for the spontaneous inquiry at the host unit, wherein the answer data is received at any time prior to evaluating the responses;
evaluating the responses against the answer data; and
displaying a graphical presentation in a manner reflective of the evaluation, wherein the steps above are repeated a plurality of times and the graphical presentation continues to progress as a function of the cumulative results of the evaluations of responses.

10. The method of claim 9 wherein the spontaneous inquiry is posed by selecting a question from at least one paper-based question set provided to the audience members.

11. The method of claim 10 wherein selecting a question comprises indicating a question identifier to the audience members, and wherein the audience members have different paper-based question sets with different questions corresponding to the question identifier indicated.

12. The method of claim 9 further comprising allowing the graphical presentation to progress as a function of responses to a series of inquiries that are pre-associated with the graphical presentation, the series of inquiries being presentable to audience members in the order in which they have been pre-associated while allowing a presenter to interject in the series of inquiries by posing a spontaneous question, the responses to the spontaneous question also affecting the progress of the graphical presentation.

13. The method of claim 12 wherein the series of inquiries are different for different audience members because the inquiries are posed by indicating question identifiers to the audience members while the audience members are referring to different paper-based question sets that have different questions corresponding to the same question identifiers.

14. An audience response system comprising:
a host unit;
a plurality of portable units communicatively linked to said host unit;
a memory; and
a processor operable for playing a game wherein a presenter can pose a series of inquiries that are pre-associated with the game, wherein as the inquiries are posed and responses are collected by transmission to the host unit from the plurality of portable units, a graphical presentation can be progressed in a manner reflective of an evaluation of the responses, and wherein the presenter can interject in the series of inquiries during the game and pose one or more spontaneously selected inquiries for which the portable units can be used to respond by audience members and the responses to the spontaneously selected inquiries also affect progress of said graphical presentation.

15. The audience response system of claim 14 wherein the series of inquiries are selected from a paper-based question-set.

16. The audience response system of claim 15 wherein as the game progresses through the series of inquiries, the portable units automatically operate in accordance with the series of inquiries by providing user interfaces settings that are appropriate for answering current inquiries.

17. The audience response system of claim 16 wherein providing user interface settings appropriate for answering current inquiries includes showing a question number on a display of the portable units that corresponds to the current inquiry being posed from the series of inquiries.

18. The audience response system of claim 16 wherein providing user interface settings appropriate for answering current inquiries includes adjusting user interface settings of the portable units automatically to reflect appropriate multiple choice selections.

19. The audience response system of claim 14 wherein when the presenter poses a spontaneous inquiry, the presenter can also initiate a command which adjusts a user interface setting on the display of the portable units.

20. The audience response system of claim 14 wherein the presenter transmits answer data to the host unit from a remote presenter unit when posing a spontaneously selected inquiry.
